(19) United States
(12) Patent Application Publication
(10) Pub. No.: US 2006/0151638 A1
(43) Pub. Date: Jul. 13, 2006

(54) Fuel-injection device, in particular for internal combustion engines with direct fuel injection

(76) Inventor: Friedrich Boecking, Stuggart (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/544,653

(22) PCT Filed: Oct. 8, 2003
(86) PCT No.: PCT/DE03/03329

§ 371 Date: Aug. 5, 2005

(30) Foreign Application Priority Data
Feb. 8, 2003 (DE) 10305187.2

(51) Int. Cl. F02M 63/00

(52) U.S. Cl. 239/533.2

(57) ABSTRACT

A fuel injection device having a housing and an outer valve element contained in the housing and having a recess containing an inner valve element that has at least one sealing section cooperating with a valve seat and an actuation section connected to sealing section. The sealing section and the actuation section have different diameters. The recess disposed in the outer valve element and containing the inner valve element has sections with different diameters, which are at least approximately matched to the diameters of the sections of the inner valve element.

### PRIOR ART

The invention relates to a fuel injection device, in particular for internal combustion engines with direct fuel injection, with a housing, with an outer valve element contained in this housing, which in turn has a recess that at least partially contains an inner valve element that has a sealing section, which cooperates with a valve seat, and has an actuation section connected to this sealing section, the two sections having different diameters.

A fuel injection device of this kind is known from DE 30 36 583 A1, which discloses an injection valve with two valve elements that are disposed coaxial to each other. An elongated, comparatively thin actuation section of the inner valve element has a comparatively thick sealing section at its end. The recess in the outer valve element, which contains the inner valve element, has a uniform diameter on the whole.

The object of the current invention is to modify a fuel injection device of the type mentioned at the beginning so that it is even more individually adapted to the specific requirements of the internal combustion engine in which it is used.

This object is attained with a fuel injection device of the type mentioned at the beginning in that the recess in the outer valve element, which contains the inner valve element, has sections with different diameters, which are at least approximately matched to the diameters of the sections of the inner valve element.

### ADVANTAGES OF THE INVENTION

In the fuel injection device according to the invention, on the one hand, the outer diameter of the inner valve element and the inner diameter of the recess in the outer valve element are stepped and are matched to one another. This allows the wall thicknesses and cross-sectional areas of the sealing sections and the actuation sections of the valve elements to be optimally adapted to the desired functions. This is primarily advantageous considering the extremely small overall dimensions (diameter of a valve element of at most a few millimeters, but at times also significantly smaller).

Advantageous modifications of the invention are disclosed in the dependent claims.

In a first modification, the invention proposes that the sealing section of the inner valve element have a smaller diameter than its actuation section. This allows the outer valve element to have a relatively large sealing section so that a sealing surface provided there is also relatively large, which facilitates hydraulic actuation of the outer valve element, primarily at low pressures. At the same time, the actuation section of the inner valve element nevertheless has a large enough diameter to lend it a high degree of rigidity.

Alternatively, the sealing section of the inner valve element can also have a larger diameter than the actuation section of the inner valve element. This has advantages if relatively large quantities of fuel are to be injected by the inner valve element, which requires fuel outlet conduits with comparatively large diameters. Arrangement of these outlet conduits is facilitated if, as above, the sealing section of the inner valve element and therefore the associated valve seat as well have a comparatively large diameter. Because of the relatively thin actuation section of the inner valve element, the actuation section of the outer valve element can have a comparatively thick wall so that in this case, the outer valve element has a high degree of rigidity on the whole.

It is also advantageous if the outer valve element has a lower guide region in which at least regions of the sealing section of the inner valve element are guided. The term “lower” used here is not absolute, but is merely understood to be relative to the fuel injection device. This achieves a very favorable centering of the inner valve element, which yields optimal and reproducible flow ratios during an injection of fuel.

Analogously, the invention also proposes that the outer valve element have an upper guide region in which at least regions of the actuation section of the inner valve element are guided (the term “upper” used here is not absolute, but is merely understood to be relative to the fuel injection device). This also has a positive effect on the centering of the inner valve element in the outer valve element and on the reduction of the actuation pressures and consequently on the quality of the fuel injection.

In a particularly advantageous embodiment of the fuel injection device according to the invention, a step disposed between the sealing section and the actuation section of the inner valve element constitutes a pressure surface. This permits a uniform distribution of the hydraulic forces acting on the inner valve element.

In a modification of this, the invention proposes that longitudinally extending recesses be provided in the circumference surface of the region of the inner valve element guided by the upper guide region and/or in the circumference surface of the upper guide region of the outer valve element. This makes it possible to exert pressure on the pressure surface through the gap between the inner valve element and the outer valve element and through the recesses in the guide region. In this case, therefore, it is possible to omit a separate, additional pressure conduit.

### DRAWINGS

Particularly preferable exemplary embodiments of the current invention will be explained in detail below in conjunction with the accompanying drawings:

FIG. 1 is a schematic depiction of a fuel system with a number of fuel injection devices;

FIG. 2 is a partial section through a region of a first exemplary embodiment of one of the fuel injection devices from FIG. 1; and

FIG. 3 is a depiction similar to FIG. 2, of a second exemplary embodiment of one of the fuel injection devices from FIG. 1.

### DESCRIPTION OF THE EXEMPLARY EMBODIMENTS

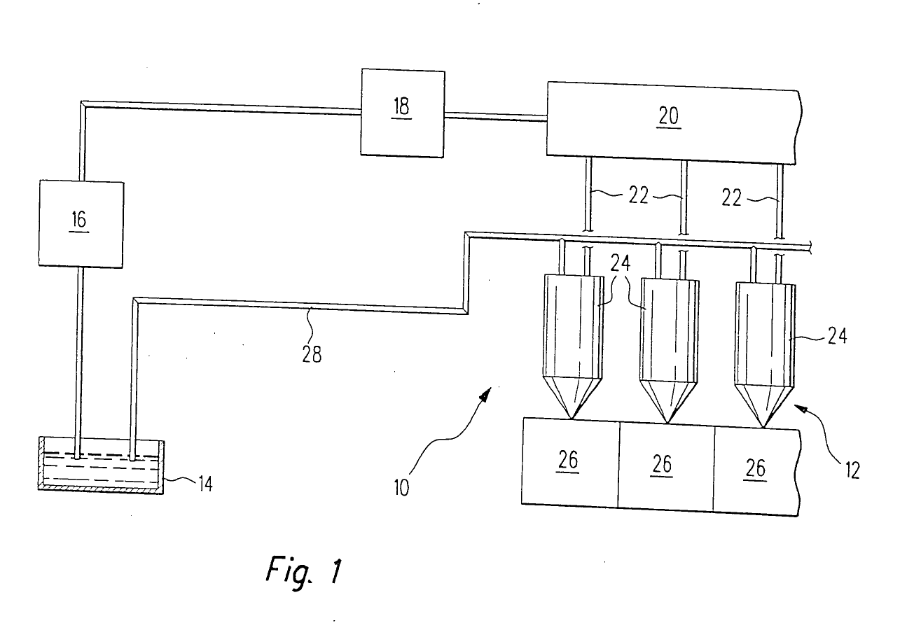

In FIG. 1, a fuel system is labeled as a whole with the reference numeral 10. It is used in an internal combustion engine 12, which is not shown in detail in FIG. 1.

The fuel system 10 includes a fuel tank 14, from which an electric fuel pump 16 delivers fuel to a high-pressure fuel pump 18. This high-pressure fuel pump 18 compresses the fuel to a very high pressure and delivers it into a fuel accumulation line (“rail”) 20. This rail is attached via high-pressure lines 22 to a number of fuel injection devices 24, which inject the fuel directly into the combustion chambers 26 associated with them. The fuel injection devices 24 are in turn connected to the fuel tank 14 via a low-pressure return line 28.

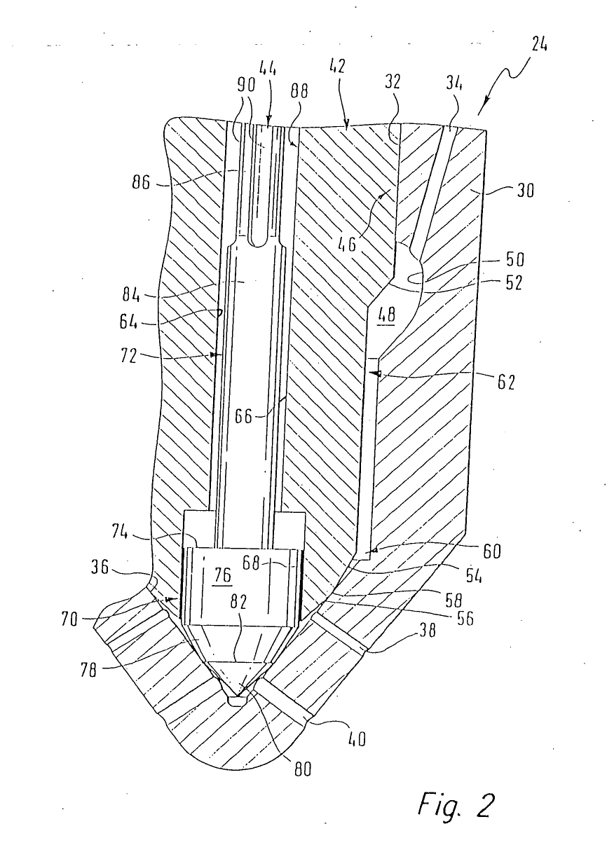

FIG. 2 gives a detailed view of a region of one of the fuel injection devices 24 oriented toward the combustion chamber 26:

In it, the fuel injection device 24 includes a housing 30 that contains a stepped blind bore 32. This is connected to the high-pressure line 22 via a conduit 34. The lower region of the stepped blind bore 32 shown in FIG. 2 tapers conically. It is bounded by a conical valve seat surface 36. The valve seat surface 36 is connected to radially outer fuel outlet conduits 38 and radially inner fuel outlet conduits 40, which are disposed distributed over the circumference of the housing 30 and pass through the housing wall.

Two valve elements that are coaxial to each other, namely an outer valve element 42 and an inner valve element 44, are disposed in the stepped blind bore 32 of the housing 30. The housing 30 guides the outer valve element 42 in a fluid-tight fashion in a guide region 46. An annular chamber 48 disposed below the guide region 46 in FIG. 2, between the outer valve element 42 and the wall of the stepped blind bore 32, is connected to the high-pressure line 22 via the high-pressure conduit 34. Directly below the guide region 46, the annular chamber 48 has a bulge 50, at the level of which, the outer valve element 42 is provided with a pressure surface 52 that acts in the opening direction of the outer valve element 42.

The lower end of the outer valve element 42 in FIG. 2 is also conically embodied, with two conical surfaces 54 and 56 of different conicities. A sealing edge 58 is formed between them. The two conical surfaces 54 and 56 with the sealing edge 58 are provided in a sealing section 60 of the outer valve element 42, whereas the pressure surface 52 is provided in an actuation section 62 of the outer valve element 42.

The inner valve element 44 is contained in a stepped bore 64 of the outer valve element 42. The stepped bore 64 has a section 66 with a smaller diameter and a section 68 with a larger diameter. In the section 68 of the stepped bore 64, the inner valve element 44 has a sealing section 70 that has a larger diameter than an actuation section 72 of the inner valve element 44, which is contained in the section 66 of the stepped bore 64 of the outer valve element 42. Between the two sections 70 and 72 of the inner valve element 44, a shoulder is formed, which constitutes an annular pressure surface 74.

The sealing surface 70 of the inner valve element 44 includes a cylindrical section 76, which is guided in a fluid-tight manner in the section 68 of the stepped bore 64. The section 68 is therefore also referred to as the “lower guide region”. In FIG. 2, below the cylinder section 76, the sealing section 70 has two regions with different conicities. These are respectively bounded by an outer conical surface 78 and an inner conical surface 80, between which a sealing surface 82 is formed. When the inner valve element 44 is closed, the sealing edge 82 rests against the valve seat surface 36 of the housing 30. Analogously, when the outer valve element 42 is closed, its sealing edge 48 rests against the same valve seat surface 36.

The actuation section 72 of the inner valve element 44 has two regions 84 and 86 with different diameters. The region 84 immediately adjoining the sealing section 70 has a slightly smaller diameter than the region 66 of the stepped bore 64 in the outer valve element 42. The outer diameter of the region 86 of the actuation section 72, however, approximately corresponds to the inner diameter of the section 66 of the stepped bore 64 in the outer valve element 42. This region of the stepped bore 62 therefore constitutes an upper guide region 88 in which the actuation section 72 of the inner valve element 44 is guided. Axially extending grooves 90 are let into the region 86 of the actuation section 72 of the inner valve element 44.

The fuel injection device 24 shown in FIG. 2 can be stroke-controlled or pressure-controlled or can be operated in a combination of these two control principles. For example, it is conceivable for the outer valve element 42 to operate in a pressure-controlled manner, i.e. an opening movement of the outer valve element 42 is produced through a pressure increase in the annular chamber 48. This increases the hydraulic force acting on the pressure surface 52 and on the outer conical surface 54, which then causes the sealing edge 58 to lift away from the valve seat surface 36 counter to a constant closing force.

The inner valve element 44 can be stroke-controlled. This means that as a result of a constant opening force, its sealing edge 82 only lifts away from the valve seat surface 36 if the hydraulic force acting on the annular pressure surface 74 in the closing direction is reduced at least temporarily. This is possible via the annular chamber disposed between the region 84 of the actuation section 72 and the inner wall of the stepped bore 64 and via the grooves 90 passing through the region 86 of the actuation section 72 of the inner valve element 44. It is also conceivable, however, for the inner valve element 44 to be pressure-controlled, i.e. in order to produce an opening movement of the inner valve element 44, a corresponding temporarily increased hydraulic pressure must be exerted on the outer conical surface 78. In this case, the annular chamber between the region 84 of the actuation section 72 and the stepped bore 64 as well as the grooves 90 in the region 86 serve to relieve the pressure on the pressure surface 74 that is formed between the actuation section 72 and the sealing section 70.

In the exemplary embodiment of a fuel injection device 24 shown in FIG. 2, the inner fuel outlet conduits 40 have a comparatively large diameter. This requires a comparatively large diameter in the region of the valve seat or in other words, a large diameter of the sealing section 70 in the region of the sealing edge 82. The stepped bore 64 in the outer valve element 42, however, permits a high degree of rigidity of the outer valve element 42 to still be achieved.

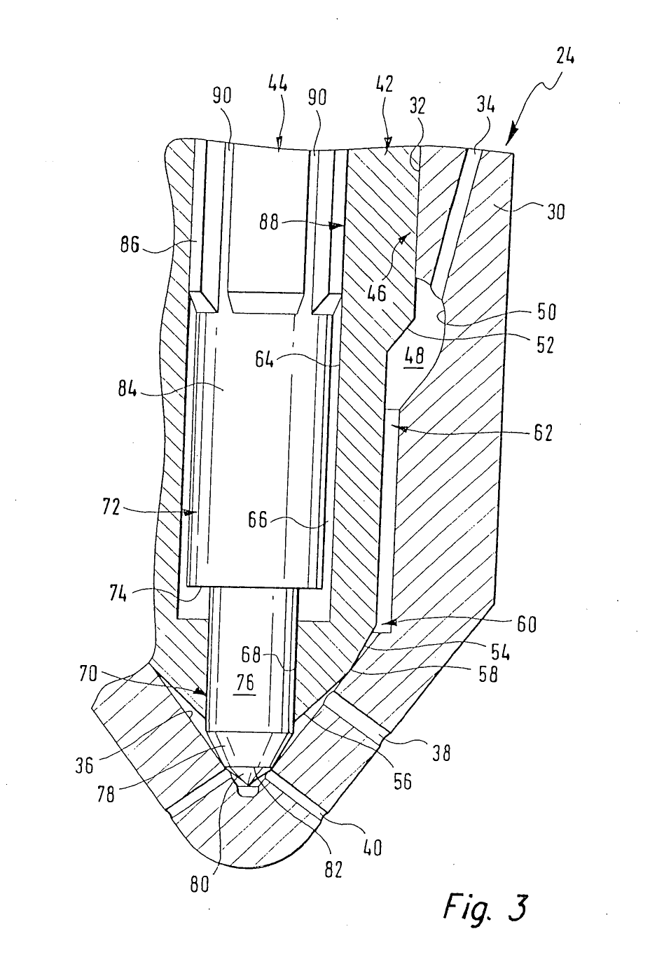

FIG. 3 shows an alternative fuel injection device 24. Elements and regions that have functions equivalent to elements and regions in the fuel injection device 24 shown in FIG. 2 have been provided with the same reference numerals. They are not discussed again in detail.

By contrast to the preceding exemplary embodiment, the sealing region 70 of the inner valve element 44 has a smaller diameter than its actuation section 72. Correspondingly, the section 66 of the stepped bore 64 in the outer valve element 42 also has a larger diameter than the section 68. In addition, the diameter of the inner fuel outlet conduits 40 is considerably smaller than in the preceding exemplary embodiment.

This allows the sealing section 60 of the outer valve element 42 to be larger on the whole so that the inner conical surface 56 can also be larger. This assures a reliable opening of the outer valve element 42 even when there are low pressures in the annular chamber 48. At the same time, high pressures are required in order to generate the hydraulic force, which acts in the opening direction on the comparatively small outer conical surface 78 of the inner valve element 44 and causes the sealing edge 82 to lift away from the valve seat surface 36. The powerful forces can be easily absorbed by the comparatively thick actuation section 72 of the inner valve element 44, i.e. this section has a sufficient degree of rigidity. The grooves 90 and the gap between the region 84 of the actuation section 72 of the inner valve element 44 and the inner wall of the stepped bore 64 can nevertheless relieve the pressure on the pressure surface 74 to a sufficient degree.

1-7. (canceled)

8. A fuel injection device (24) for internal combustion engines (12) with direct fuel injection, the injection device comprising
a housing (30),
an outer valve element (42) contained in the housing (30),
an inner valve element (44),
a recess (64) in the outer valve element (42) that at least partially contains the inner valve element (44),
the inner valve element (44) having at least one sealing section (70) cooperating with a valve seat (36) and an actuation section (72) connected to the sealing section (70), these sections (70, 72) having different diameters, and
the recess (64) in the outer valve element (42) containing the inner valve element (44) having sections (66, 68) with different diameters which are at least approximately matched to the diameters of the sections (70, 72) of the inner valve element (44).

9. The fuel injection device (24) according to claim 8, wherein the sealing section (70) of the inner valve element (44) has a smaller diameter than its actuation section (72).

10. The fuel injection device (24) according to claim 8, wherein the sealing section (70) of the inner valve element (44) has a larger diameter than its actuation section (72).

11. The fuel injection device (24) according to claim 8, wherein the outer valve element (42) comprises a lower guide region (68) in which at least regions of the sealing section (70) of the inner valve element (44) are guided.

12. The fuel injection device (24) according to claim 9, wherein the outer valve element (42) comprises a lower guide region (68) in which at least regions of the sealing section (70) of the inner valve element (44) are guided.

13. The fuel injection device (24) according to claim 10, wherein the outer valve element (42) comprises a lower guide region (68) in which at least regions of the sealing section (70) of the inner valve element (44) are guided.

14. The fuel injection device (24) according to claim 8, wherein the outer valve element (42) comprises an upper guide region (88) in which at least regions of the actuation section (72) of the inner valve element (44) are guided.

15. The fuel injection device (24) according to claim 9, wherein the outer valve element (42) comprises an upper guide region (88) in which at least regions of the actuation section (72) of the inner valve element (44) are guided.

16. The fuel injection device (24) according to claim 10, wherein the outer valve element (42) comprises an upper guide region (88) in which at least regions of the actuation section (72) of the inner valve element (44) are guided.

17. The fuel injection device (24) according to claim 11, wherein the outer valve element (42) comprises an upper guide region (88) in which at least regions of the actuation section (72) of the inner valve element (44) are guided.

18. The fuel injection device (24) according to claim 12, wherein the outer valve element (42) comprises an upper guide region (88) in which at least regions of the actuation section (72) of the inner valve element (44) are guided.

19. The fuel injection device (24) according to claim 13, wherein the outer valve element (42) comprises an upper guide region (88) in which at least regions of the actuation section (72) of the inner valve element (44) are guided.

20. The fuel injection device (24) according to claim 8, further comprising a step disposed between the sealing section (70) and the actuation section (72) of the inner valve element (44), the step constituting a pressure surface (74).

21. The fuel injection device (24) according to claim 9, further comprising a step disposed between the sealing section (70) and the actuation section (72) of the inner valve element (44), the step constituting a pressure surface (74).

22. The fuel injection device (24) according to claim 11, further comprising a step disposed between the sealing section (70) and the actuation section (72) of the inner valve element (44), the step constituting a pressure surface (74).

23. The fuel injection device (24) according to claim 12, further comprising a step disposed between the sealing section (70) and the actuation section (72) of the inner valve element (44), the step constituting a pressure surface (74).

24. The fuel injection device (24) according to claim 13, further comprising a step disposed between the sealing section (70) and the actuation section (72) of the inner valve element (44), the step constituting a pressure surface (74).

25. The fuel injection device (24) according to claim 14, further comprising a step disposed between the sealing section (70) and the actuation section (72) of the inner valve element (44), the step constituting a pressure surface (74).

26. The fuel injection device (24) according to claim 8, wherein the outer valve element (42) comprises an upper guide region (88) in which at least regions of the actuation section (72) of the inner valve element (44) are guided, and further comprising a step disposed between the sealing section (70) and the actuation section (72) of the inner valve element (44), the step constituting a pressure surface (74), and longitudinally extending recesses (90) in the circumference surface of the region of the inner valve element (44) guided by the upper guide region (88) and/or in the circumference surface of the upper guide region of the outer valve element.
